(19) United States
(12) Patent Application Publication
(10) Pub. No.: US 2007/0222111 A1
(43) Pub. Date: Sep. 27, 2007

(54) Apparatus and method for injection molding a multilayer container or container preform, or injection blow molding a multilayer container

(75) Inventors: Tasadduq Hussain, Maumee, OH (US); Bruce A. Mohrmann, Waterville, OH (US)

Correspondence Address: OWENS-ILLINOIS, INC., ONE MICHAEL OWENS WAY, THREE O-I PLAZA, PERRYSBURG, OH, 43551-2999, US

(73) Assignee: Owens-Illinois HealthCare Packaging Inc.

(21) Appl. No.: 11/387,664

(22) Filed: Mar. 23, 2006

(51) Int. Cl. B29C 45/16

(52) U.S. Cl. 264/255; 264/328.12; 425/564; 425/562

(57) ABSTRACT

Apparatus for injection molding a multilayer container or a multilayer container preform includes an injection mold cavity and a nozzle for injecting resin into the cavity from at least first and second resin sources in sequence to form a multilayer container or preform in which at least one layer of resin from the second source is disposed between layers of resin from the first source. A deflector element is selectively positionable within the mold cavity during injection of resin from the second source to distribute the resin from the second source during injection such that the layer of resin from the second source is disposed between layers of resin from the first source that preferably are of substantially equal thickness. The mold cavity preferably has a gate through which the resins are injected, and the deflector element preferably is selectively positionable within the cavity adjacent to the gate.

The present disclosure relates to injection molding multilayer containers or multilayer preforms for blow molding into multilayer containers.

### BACKGROUND AND SUMMARY OF THE DISCLOSURE

In general, the art of injection molding multilayer preforms and containers divides into processes for simultaneous injection of the preform or container layers and processes for sequential injection of the preform or container layers. The present disclosure relates to sequential injection of preform layers, and to sequential injection of layers of an injection molded container. U.S. patents relating to sequential injection of layers in multilayer preforms include U.S. Pat. Nos. 4,609,516, 4,710,118 and 4,954,376. Employing current technology for injection molding a three-layer preform, for example, in which a layer of barrier resin is disposed between layers of matrix resin, the resin of the intermediate barrier layer, for various reasons, tends to travel close to the mold core so that the innermost layer of matrix resin is thinner than the outermost layer of matrix resin. These uneven matrix resin layer thicknesses can permit moisture to migrate into the barrier resin layer and deleteriously affect the barrier properties of the intermediate barrier layer. The same is true of five layer preforms that include innermost and outermost layers of matrix resin and intermediate layers of barrier resin spaced from each other by an inner layer of matrix resin.

The present disclosure embodies a number of aspects that can be implemented separately from or in combination with each other.

Apparatus for injection molding a multilayer container or a multilayer container preform, in accordance with one aspect of the present disclosure, includes an injection mold cavity and a nozzle for injecting resin into the cavity from at least first and second resin sources in sequence to form a multilayer container or preform in which at least one layer of resin from the second source is disposed between layers of resin from the first source. A deflector element is selectively positionable within the mold cavity during injection of resin from the second source to distribute the resin from the second source during injection such that the layer of resin from the second source is disposed between layers of resin from the first source, preferably of substantially equal thickness. The mold cavity preferably has a gate through which the resins are injected, and the deflector element preferably is selectively positionable within the cavity adjacent to the gate.

Apparatus for injection molding a multilayer container or a multilayer container preform, in accordance with another aspect of the present disclosure, includes an injection mold cavity having a gate opening into an end of the cavity, and a nozzle for injecting resin into the cavity through the gate from at least first and second resin sources in sequence to form a multilayer container or a multilayer container preform in which at least one layer of resin from the second source is disposed between layers of resin from the first source. A gate pin is coupled to a gate pin control for selectively positioning the gate pin at a first position blocking flow of resin through the gate, a second position spaced from the gate and from the mold cavity for permitting flow of the first resin through the gate into the cavity, and a third position extending through the gate into the mold cavity for deflecting flow of the second resin into the mold cavity. The gate pin preferably has a head of diameter to block flow of resin through the gate and a neck of reduced diameter adjacent to the head to permit flow of the second resin through the gate into the mold cavity when the head is positioned within the mold cavity.

A method of injection molding a multilayer container or a multilayer container preform, in accordance with a further aspect of the present disclosure, includes providing an injection mold cavity having a gate, and injecting a first resin through the gate into the mold cavity. A deflector element is positioned within the cavity adjacent to the gate, and a second resin is then injected through the gate around the deflector element into the mold cavity to form a layer of the second resin disposed between layers of the first resin of substantially equal thickness. The deflector element may be withdrawn from the mold cavity, and a third resin may be injected through the gate into the mold cavity to form a layer between layers of the second resin. The third resin may be the same as the first resin.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a sectioned elevational view of a container in accordance with an exemplary implementation of the present disclosure;

FIG. 2 is a sectional view on an enlarged scale of the portion of FIG. 1 within the area 2;

FIG. 3 is a sectional view on an enlarged scale that illustrates a modification to the embodiment of FIGS. 1 and 2;

FIGS. 4A-4D are schematic diagrams that illustrate injection molding a multilayer container or container preform in accordance with an exemplary embodiment of the present disclosure; and

FIG. 5 is a schematic diagram of an apparatus for injection blow molding a container.

### DETAILED DESCRIPTION OF PREFERRED EMBODIMENTS

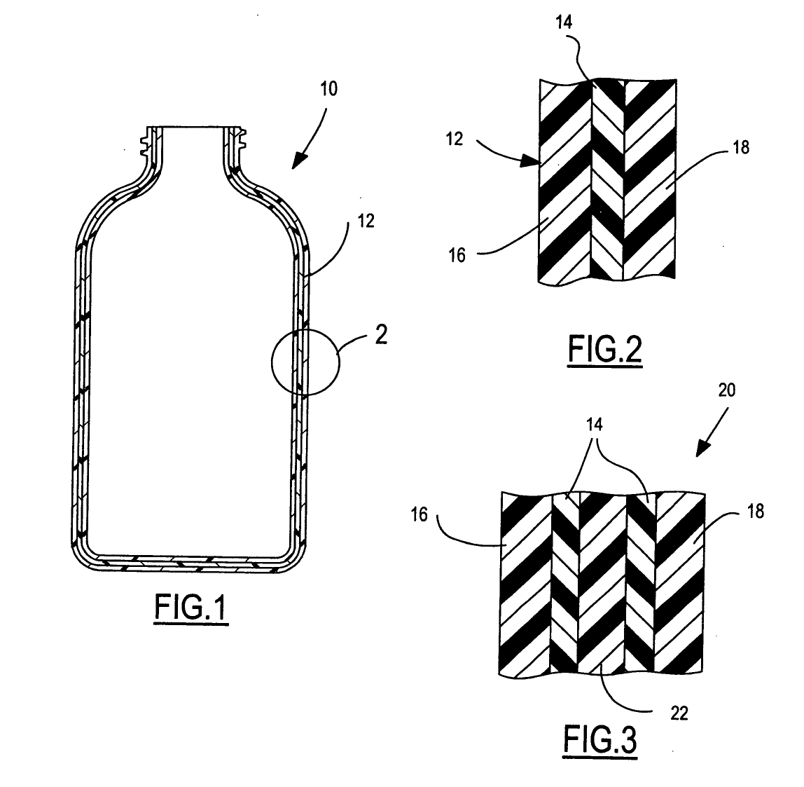

FIG. 1 illustrates a container 10 in accordance with an exemplary implementation of the present disclosure. Container 10 includes at least a sidewall 12 of multilayer construction, preferably including an intermediate layer 14 (FIG. 2) positioned between innermost and outermost layers 16,18. Container 10 preferably is blow molded from a multilayer preform. As an alternative, container 10 may be a multilayer injection molded container. Intermediate layer 14 may be of any suitable material, of which barrier resin material such as ethylene vinyl alcohol (EVOH) and nylon are two examples. Innermost and outermost layers 16,18 may be of any suitable material, of which matrix resin such as polyethylene terephthalate (PET) is an example. FIG. 3 illustrates a modified sidewall construction 20 that includes innermost and outermost layers 16,18 of the same material, spaced intermediate layers 14 of the same material, and an innermost layer 22 disposed between intermediate layers 14. Innermost layer 22 preferably is of the same material as innermost and outermost layers 16,18.

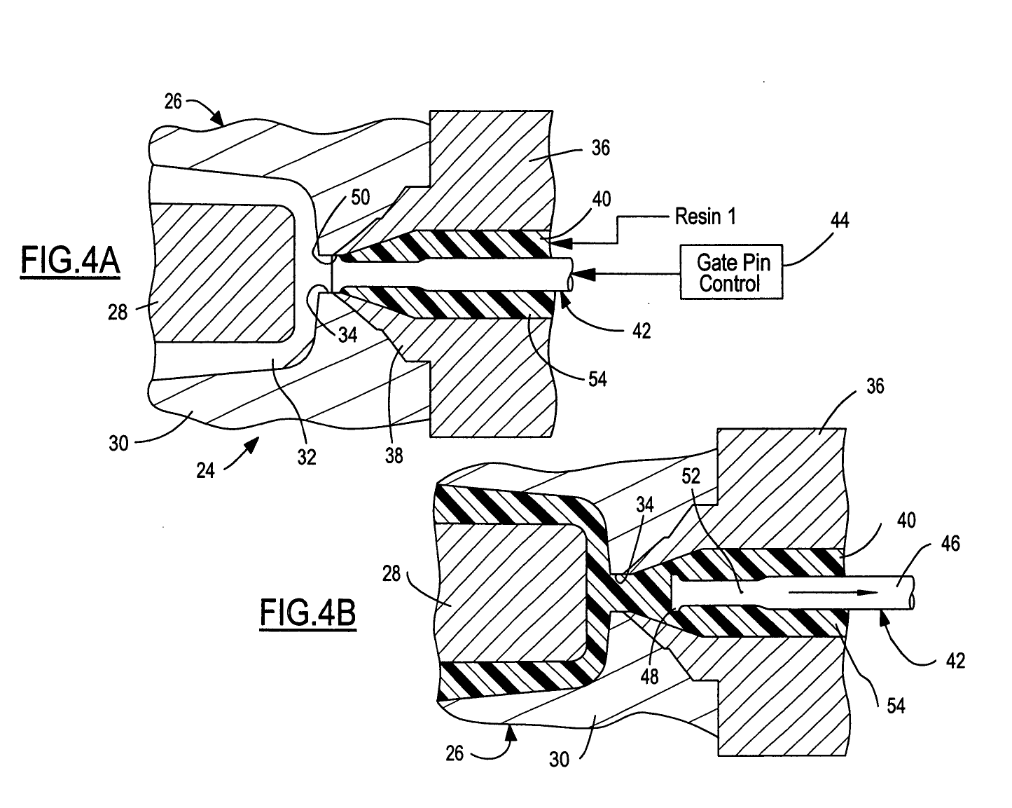

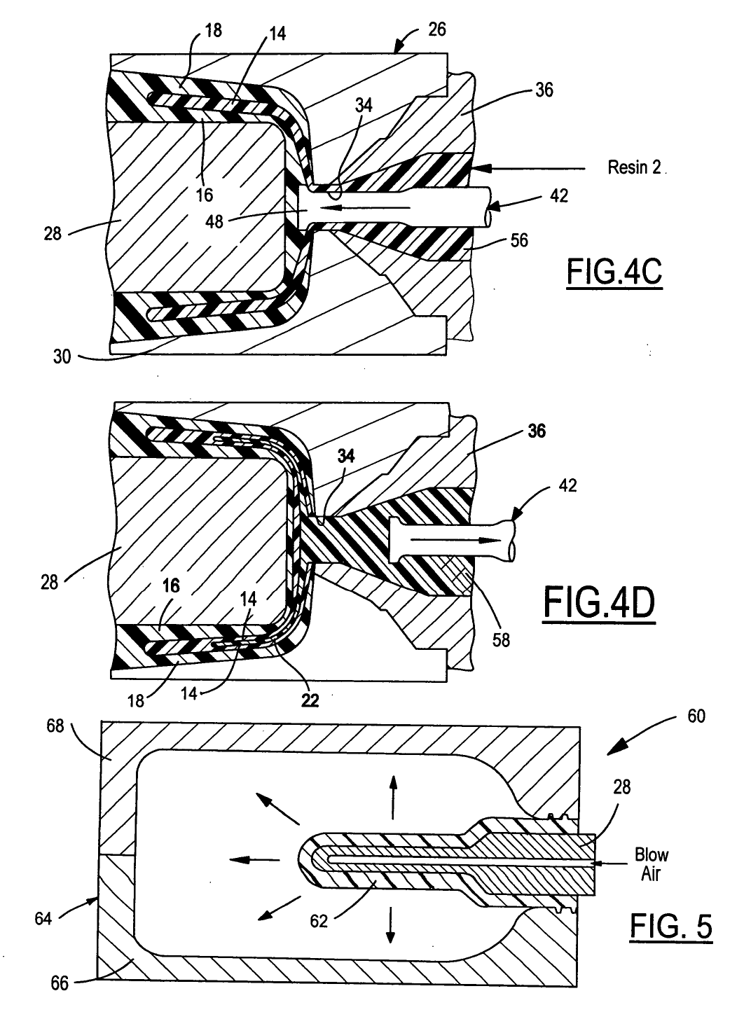

FIGS. 4A-4D are schematic diagrams that illustrate an apparatus 24 for injection molding a multilayer container or a multilayer container preform in accordance with an exemplary embodiment of the present disclosure. Apparatus 24 includes a mold 26 in which a mold core 28 is disposed within an outer mold element 30 to form a mold cavity 32 between the mold elements. A gate 34 is coupled to the otherwise closed end of cavity 32 for feeding resin into the mold cavity. A nozzle 36 has a tip 38 that registers with gate 34, and one or more passages 40 for feeding resin through the gate into the mold cavity. A gate pin 42 is coupled to a gate pin control 44 for selectively positioning gate pin 42 within passage 40. Gate pin control 44 can be electrical, hydraulic or pneumatic. In the illustrated embodiment of the present disclosure, gate pin 42 includes a body 46, typically cylindrical, and a head 48 contoured for close receipt within the nozzle outlet opening 50 to block passage of resin through gate 34 into cavity 32. A neck 52 connects head 48 with body 46 of gate pin 42. Neck 52 is of reduced diameter as compared with head 48, and preferably blends smoothly into the outer diameter of head 48 so as not to induce turbulence into resin flowing past the neck and head.

FIG. 4A illustrates the starting position of gate pin 42, in which head 48 blocks flow of a first resin through gate 34 into cavity 32. Gate pin 42 is then moved by gate pin control 44 to a second position illustrated in FIG. 4B, in which a first resin 54 is allowed to flow through nozzle outlet opening 50 and gate 34 into cavity 32. Gate pin 42 is then moved by control 44 to the third position illustrated in FIG. 4C, in which head 48 of gate pin 42 is disposed within cavity 32 adjacent to gate 34. In this position, when a second resin 56 is injected through nozzle 36 and gate 34, head 48 deflects flow of the second resin within the mold cavity so that the layer 58 of the second resin is disposed at a controlled position with respect to innermost and outermost layers 16,18 of the first resin, preferably with innermost and outermost layers 16,18 being of substantially identical thickness. Injection of second resin 56 continues until layer 14 is of desired length as compared with the length of the preform or container, at which point gate pin 42 is returned to the position of FIG. 4A and injection of the three-layer container or preform is complete.

FIG. 4D illustrates exemplary continuation of the process of FIGS. 4A-4C for injection molding a five-layer container or preform as illustrated in FIG. 3. In the gate pin position of FIG. 4D, a third resin 58 is injected through gate 34 to form the inner layer 22 between spaced intermediate layers 14. Third resin 58 preferably is the same as first resin 54 (FIGS. 4A and 4B), although a different resin such as post consumer resin could be employed for inner layer 22 in FIG. 3.

FIG. 5 is a schematic diagram of an apparatus 60 for blow molding container 10 (FIG. 1) from a preform, preferably in an injection blow molding apparatus. Mold core 28 with a preform 62 injection molded thereon is placed within a mold 64 comprised of at least two mold segments 66,68. Blow air is applied to the preform to expand the preform to the confines of the mold cavity formed by mold segments 66,68. As an alternative, the preform could be removed from core 28 and expanded in a reheat blow molding apparatus.

There thus have been provided an apparatus and method for injection molding an intermediate layer in a multilayer injection molded container or preform, in which the position of the intermediate layer can be affirmatively controlled, preferably positioned between innermost and outermost layers of substantially identical thickness. The disclosure has been presented in conjunction with a number of exemplary embodiments, and alternatives and modifications have been discussed. Other modifications readily will suggest themselves to persons of ordinary skill in the art in view of the foregoing description. The disclosure is intended to embrace all such modifications and variations as fall within the spirit and broad scope of the appended claims.

1. Apparatus for injection molding a container or a container preform, which includes:
an injection mold cavity,
a nozzle for injecting resin into said cavity from first and second resin sources in sequence to form a multilayer container or preform in which at least one layer of resin from said second source is disposed between layers of resin from said first source, and
a deflector element selectively positionable within said mold cavity during injection of resin from said second source to distribute said resin from said second source during injection such that said layer of resin from said second source is disposed between layers of resin from said first source of substantially equal thickness.

2. The apparatus set forth in claim 1 wherein said mold cavity has a gate through which said resins are injected, and said deflector element is selectively positionable within said cavity adjacent to said gate.

3. The apparatus set forth in claim 2 wherein said deflector element includes a gate pin that is selectively positionable with respect to said gate at a first position blocking flow of material through said gate, a second position spaced from said gate and said cavity for permitting flow of resin from said first source through said gate into said cavity, and a third position extending through said gate into said cavity for deflecting flow of resin from said second source into said cavity.

4. Apparatus for injection molding a container or a container preform, which includes:
an injection mold cavity having a gate opening into an end of said cavity,
a nozzle for injecting resin into said cavity from at least first and second resin sources in sequence to form a multilayer container or preform in which at least one layer of resin from said second source is disposed between layers of resin from said first source, and
a gate pin coupled to a gate pin control for selectively positioning said gate pin at a first position blocking flow of material through said gate, a second position spaced from said gate and said cavity for permitting flow of resin from said first source through said gate into said cavity, and a third position extending through said gate into said cavity for deflecting flow of resin from said second source into said cavity.

5. The apparatus set forth in claim 4 wherein said gate pin control is adapted to position said gate pin in said third position to deflect resin from said second source during injection such that at least one layer of resin from said second source is disposed between layers of resin from said first source of substantially equal thickness.

6. The apparatus set forth in claim 4 wherein said gate pin has a head of diameter to block flow of resin through said gate, and a neck adjacent to said head of reduced diameter to permit flow of resin through said gate when said head is positioned within said mold cavity.

7. A method of injection molding a container or a container preform, which includes the steps of:
(a) providing an injection mold cavity having a gate,
(b) injecting a first resin through said gate into said cavity,
(c) positioning a deflector element within said cavity adjacent to said gate, and
(d) injecting a second resin through said gate around said deflector element such that said second resin forms a layer disposed between layers of resin of said first resin of substantially equal thickness.

8. The method set forth in claim 7 wherein said step (c) includes moving said deflector element through said gate into said cavity.

9. The method set forth in claim 7 including:
(e) removing said deflector element from within said cavity, and
(f) injecting a third resin through said gate to form a layer within said layer of second resin.

10. The method set forth in claim 9 wherein said first and third resins are identical.

11. A container preform made in accordance with the method set forth in claim 10.

12. A container made in accordance with the method set forth in claim 10.

13. A container preform made in accordance with the method set forth in claim 8.

14. A container made in accordance with the method set forth in claim 8.
